(19) United States
(12) Patent Application Publication
(10) Pub. No.: US 2026/0200687 A1
(43) Pub. Date: Jul. 16, 2026

(54) VIBRATORY CONVEYORS AND METHOD FOR VIBRATORY CONVEYING OF BULK MATERIAL

(71) Applicant: CiTEX Holding GmbH, Melle (DE)

(72) Inventors: David WINKING, Georgsmarienhütte (DE); Markus STENING, Melle (DE); Marius THIEL, Osnabrück (DE)

(21) Appl. No.: 19/445,896

(22) Filed: Jan. 12, 2026

(30) Foreign Application Priority Data
Jan. 13, 2025 (DE) 102025100874.4

(51) Int. Cl. B65G 65/44; B65G 47/20; B65G 53/66

(52) U.S. Cl. CPC B65G 65/44; B65G 47/20; B65G 53/66; B65G 2201/04

(57) ABSTRACT

The present disclosure relates to a vibratory conveyor for transporting bulk material, wherein the vibratory conveyor comprises: a feed hopper with a hopper outlet formed at the lower end of the feed hopper, a conveying trough, and a vibration drive for driving the conveying trough with a vibration amplitude and a vibration frequency, wherein a discharge gap with a gap height is formed between the hopper outlet and the conveying trough. It is provided that the hopper comprises a hopper body and a slider that is vertically adjustable on the hopper body, wherein the hopper outlet is formed on the slider and the slider is vertically adjustable upwards from a lower stop relative to the hopper body, thereby enlarging the discharge gap.

### PRIORITY CLAIM

This application claims priority to German Patent Application No. DE102025100874.4, filed January 13, 2025, which is expressly incorporated by reference herein.

### BACKGROUND

The present disclosure relates to a vibratory conveyor and a method for vibratory conveying bulk material.

### SUMMARY

The present disclosure provides a vibratory conveyor and a method for vibratory conveying bulk material, which enable safe vibratory conveying and good adjustability of the material throughput with little effort.

This task is solved by a vibratory conveyor and a method according to the independent claims. The dependent claims describe preferred further developments.

Thus, the feed hopper comprises a hopper body and a slider that is adjustable vertically on the hopper body, whereby the hopper outlet, from which the filling material is discharged onto the conveying trough via a discharge gap, is formed on the slider.

In illustrative embodiments, the slider is not actively adjusted upwards, but is pressed downwards against a stop, in particular a stop on the hopper body, by a total force. The total force includes the gravitational force of the slider; it can be formed in particular by the gravitational force itself, so that the slider is pressed down against the stop by its own gravitational force, or also by the gravitational force and an additional downward spring force.

The adjustability of the slider thus differs from the height adjustment of the entire feed hopper relative to the conveying trough for adjusting the discharge gap; In the comparative height adjustment of the entire feed hopper relative to the conveying trough, the hopper body and the slider are adjusted together to set the gap height for the proper material throughput;

In contrast, the vertical adjustment of the slider on the hopper body according to the present disclosure is advantageously performed passively by the action of an upward force of the filling material on the lower edge of the slider, i.e., the hopper outlet. This upward force is caused by material jam in the discharge gap.

This relatively simple measure can surprisingly achieve a significant improvement in conveying operation and, in particular, prevent material jam even at low gap heights:

In illustrative embodiments, it is recognized that when material jams, a solid accumulation of material is formed between the conveying trough and the hopper outlet, which during operation, i.e., vibration of the conveying trough, presses against the outlet opening and thus the hopper from below. By attaching the hopper outlet to a vertically adjustable slider, the slider is moved directly vertically upwards, i.e., against its gravitational force, when such a material jam occurs, so that the slider opens automatically upwards when a material jam occurs, thereby increasing the discharge gap and the gap height.

In illustrative embodiments, the problem of material jam may arise when the accumulation of particles of the filling material exerts a force on the hopper outlet from below due to the oscillating drive, and the hopper outlet exerts a counterforce downward in response to this. This counterforce enables the force connection from the hopper outlet to the conveying trough via the particles, in order to reduce this influence, the present disclosure reduces the counterforce that the slider can exert. To this end, the comparative fixed positioning of the lower hopper outlet is eliminated and the slider is given the opportunity to yield against the upward force. Thus, in particular, the maximum counterforce that it can exert is limited to a total force acting downward.

It can be seen that the total downward force acting on the slide valve is basically sufficient to counteract its own vertical gravitational force; in addition, a downward spring force, in particular a travel-dependent spring force, can be used.

In this case, the total force exerted downward by the slider is sufficient to prevent it from being displaced upward by the conveyed bulk material during regular operation and material transport, or at least to prevent any significant displacement. If the bulk material in the conveying trough is a fully fluidized material, the bulk material exerts a static buoyancy force on the slider, which is generally low, however. According to the present disclosure, it has been shown that the transported fluidized bulk material does not exert any relevant buoyancy and that the total force acting on the slider, i.e., in particular its gravitational force, is sufficient to provide that it can be safely moved back to the lower position.

The total force thus also provides that the slider is reset after a material jam; the material jam pushes the slider upward until the force connection is released and the material jam is cleared, allowing the slider to fall back down against its stop due to the total force. This also prevents the gap from being pushed open further and further by subsequent material flow or from remaining open.

This means that the fundamentally disadvantageous friction that occurs when material jams between the conveying trough and the lower hopper outlet now formed on the slider can be exploited in accordance with the present disclosure to briefly open the gap height by adjusting the slider, whereupon, with normal material flow, there is no longer sufficient vertical upward force and the slider can thus fall downwards into its basic position.

The lower position or basic position is determined by a stop, which is preferably provided on the hopper body or relative to the hopper body.

The conveying trough is not limited to a rectangular chute geometry; other chute geometries, such as a V-shape or round cross-section, may also be provided. Furthermore, the slider is not limited to the exact cross-section of the conveying trough, but may also deviate from it to some extent and thus feed material into parts of the chute even when the minimum discharge gap is set. This means that channels can be provided in which material is transported at the minimum gap setting, resulting in more uniform conveying behavior.

In illustrative embodiments, the adjustable slider differs in particular from, for example, merely flexible designs such as a rubber flap or other flexible lower ends. Such a flexible lower end as a rubber flap cannot define an exact gap height, as it yields under the pressure of the bulk material in the conveying direction, i.e., even without material jam, which prevents the material throughput from being set precisely.

In illustrative embodiments, in particular, no adjustment is exerted by pressure from the material acting in the conveying direction, i.e. – different to rubber flaps and other flexible boundaries – no adjustment is caused by the material flow, and only the force connection between the conveying trough and the hopper outlet provided on the slider leads to the vertical force that adjusts the slider upwards via the oscillating drive.

Since the shape of the slider, which also forms the lower hopper outlet, basically corresponds to the cross-section of the conveying trough, a uniform discharge gap is formed across the width. Preferably, the shape of the slider may deviate slightly from the cross-section of the conveying trough; in particular, the slider may have a recess relative to the cross-section of the conveying trough, so that a free channel corresponding to the recess is formed between the slider and the conveying trough, in particular at the lower bottom area of the conveying trough. Thus, even in the lowest position of the slider, the free channel is preferably formed; according to the present disclosure, it is recognized that this small free channel is not relevant, since no relevant quantities of bulk material pass through it in the rest state, but the free channel forms a significantly more uniform material flow.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a vibratory conveyor according to one embodiment;

FIGS. 2A-2C show embodiments of channels and sliders with different geometries;

FIGS. 3A and 3B show embodiments of the slider and its suspension with and without spring support;

FIG. 4 is a representation of the channel with slider and discharge gap; and

FIG. 5 shows a material jam in the discharge gap.

### DETAILED DESCRIPTION

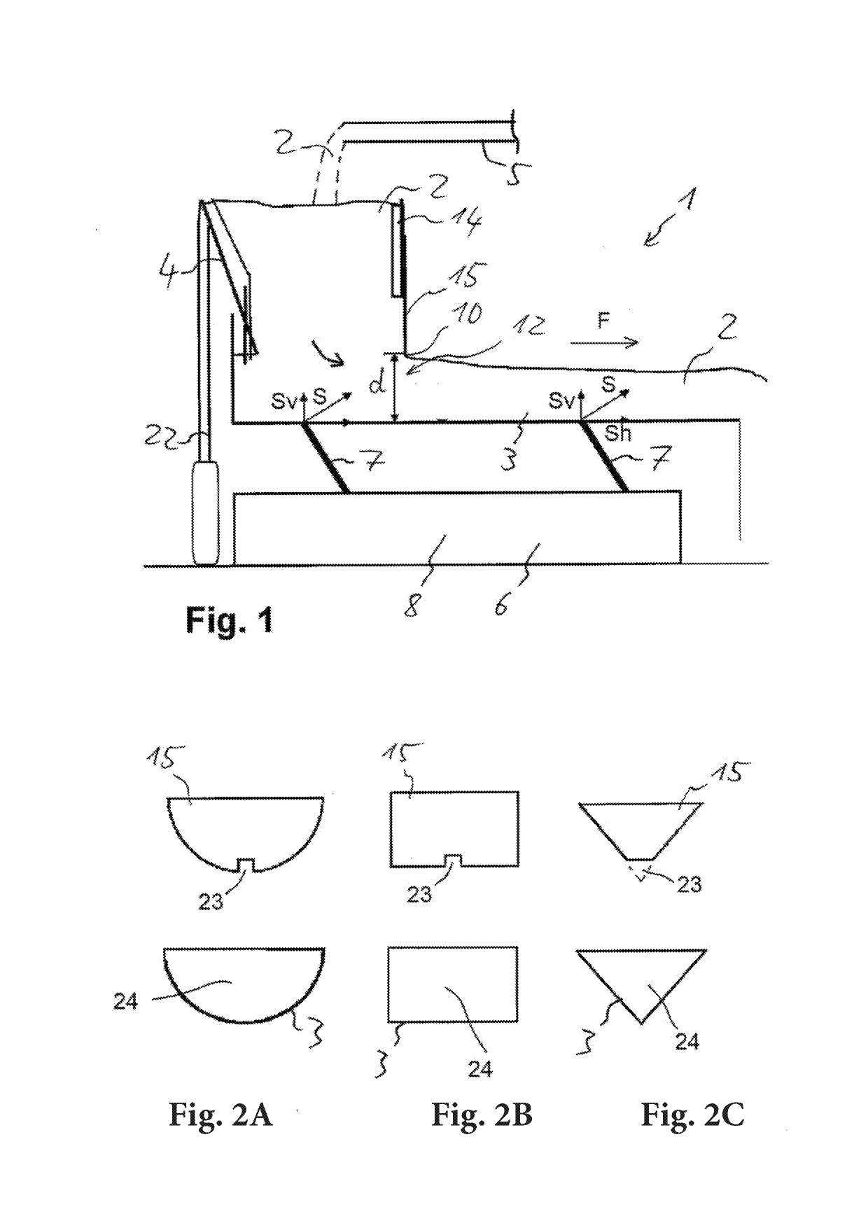

A vibratory conveyor 1 for conveying bulk material 2 comprises a conveying trough (vibratory trough) 3 and a feed hopper 4, to which the bulk material 2 is fed by a material supply 5. The conveying trough 3 is driven by a vibration drive 6 with vibration drive arms 7, e.g., leaf springs, to transport the bulk material. The vibration drive arms 7 are mounted or articulated on a vibration drive base 8 and are driven by a vibrating or vibratory mechanism of the vibration drive base 8, i.e., they are swung at an excitation angle with an excitation frequency. The drive of the oscillating mechanism or the oscillating drive arms 7 can be connected "directly" to the base; furthermore, the oscillating drive and the conveying trough 3 can also be attached to separate oscillating drive arms 7 at the same base point, for example. Thus, the conveying trough 3 is periodically moved back and forth with a vibration amplitude S, which is shown somewhat enlarged and clearly in FIG. 1. The bulk material 2 picked up is thus subjected to impacts by the conveying trough 3, through which it is conveyed in the conveying direction F. In FIG. 1, the vibration amplitude S is shown divided into a vertical component Sv and a horizontal component Sh, which thus form the vibration amplitude S as a vector sum.

The feed hopper 4 comprises a lower hopper outlet 10 as its lower edge, so that a discharge gap 12 with a gap height d is defined between the lower hopper outlet 10 and the conveying trough 3 or the lower bottom of the conveying trough 3. The bulk material 2 is fundamentally flowable and is thus continuously transported away in the conveying direction F by the driven conveying trough 3, so that bulk material 2 continuously slides out of the feed hopper 4.

The conveying quantity is determined by the cross-section of the discharge gap 12, which thus determines the material cross-section in the conveying trough 3, and the vibration amplitude S. Thus, the conveying quantity can generally be adjusted by adjusting the gap height d and the vibration amplitude S. The dependence of the delivery rate, i.e., in particular, the bulk material delivered per unit of time, on the vibration amplitude S is generally more complex, since this dependence depends on the ratio of the excitation frequency and the natural frequency, in particular of the vibration drive arms 7, for example, leaf springs, and the power exerted by the vibration drive 6.

The material cross-section in the conveying trough 3 is generally determined by the geometry of the conveying trough 3 and the gap height d, which thus defines a cross-sectional area that limits the possible total load of the vibratory conveyor 1.

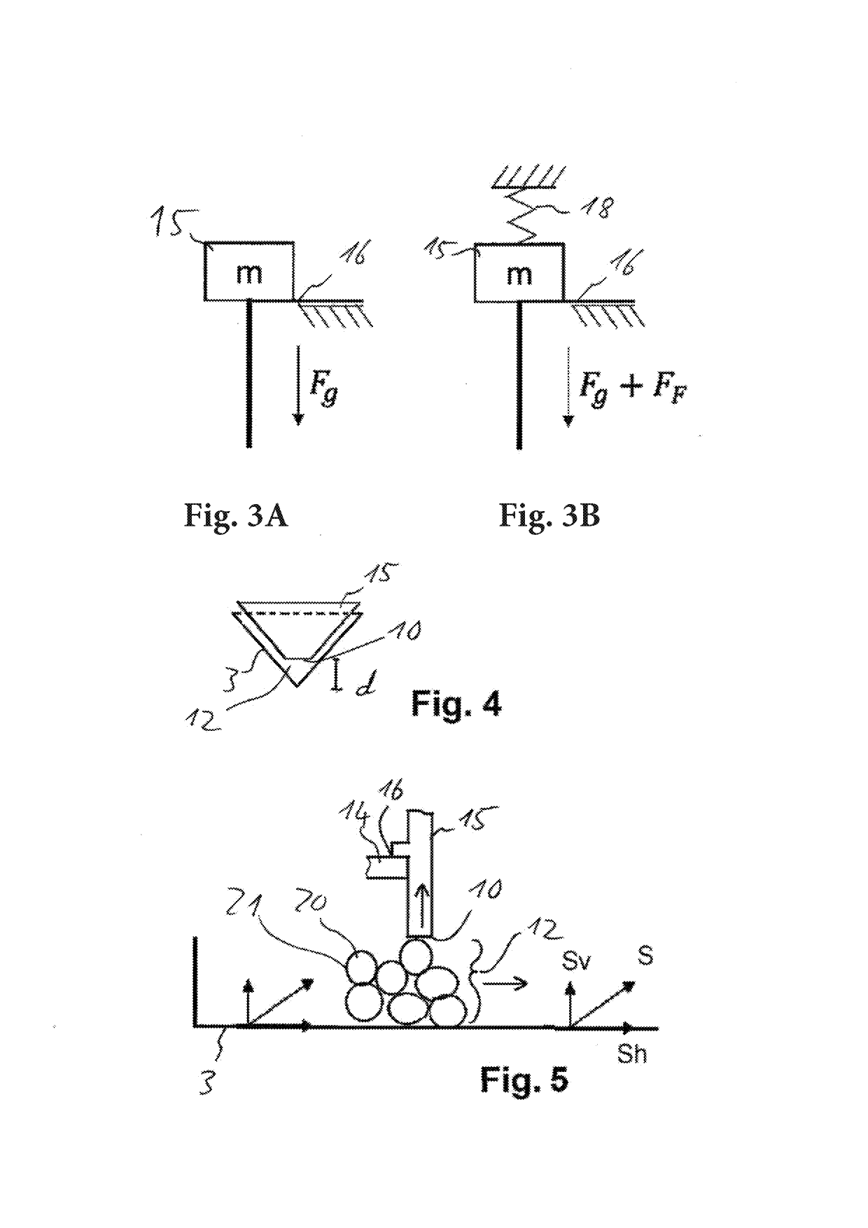

The feed hopper 4 comprises a hopper body 14 and a slider 15 provided on the hopper body 14, at the lower end of which the hopper outlet 10 or the hopper end is formed. The slider 15 is mounted on the hopper body 14 in a height-adjustable manner, e.g., as a pipe mounted on the hopper body 14. According to the embodiment of FIG. 1, the slider 15 is not spring-loaded, so that it is pulled down solely by the force of gravity. A stop 16 is provided, as illustrated in the schematic representation of FIG. 3, so that the slider 15 can be freely adjusted upwards and then fall downwards again against the stop 16 due to the force of gravity. The gap height d is thus determined in the lower or lowest position of the slider 15; lifting the slider 15 temporarily increases the gap height or the outlet gap 12 accordingly.

As shown in FIG. 3 on the right, the slider 15 can additionally be preloaded downwards by a spring 18 provided between the slider 15 and, for example, the hopper body 14, so that a total force F acts downwards on the slider 15, which is formed as the sum of the gravitational force Fg and the spring force Ff.

During operation of the vibratory conveyor 1, the conveying trough 3 is thus driven periodically or cyclically with the vibration amplitude S, so that the bulk material 2 received on the conveying trough 3 experiences corresponding throws or impacts in the conveying direction F and upwards, which lead to the transport of the bulk material 2 in the conveying direction F. In this case, a material jam can generally occur in the conveying trough 3 below the material outlet or hopper outlet 10 if, as indicated in FIG. 5, the gap height d is so small that several particles 20 stick together or become wedged in such a way that they become jammed between the hopper outlet 10 and the conveying trough 3. This results in a material jam 21, in which an accumulation of particles 20 is force-fit against both the conveying trough 3 and the hopper outlet 10. The particles 20 of the material jam 21 are thus pressed against the hopper outlet 10, which can withstand this load if it is rigid. However, since, according to the present disclosure, the lower hopper outlet 10 is fixed by the slider 15, in such a situation of material jam 21, the slider 15 yields vertically upwards, so that the gap height d is increased and a temporary increased gap height dt is formed, whereby the flow of bulk material is correspondingly increased for a short time. However, since the bulk material 2 no longer exerts a direct counterforce on the lower hopper outlet 10 of the slider 15 when the material jam 21 is resolved, the hopper 15 is again pressed downwards by its gravitational force Fg, in accordance with the further embodiment of FIG. 3, by the total force F. The total force F is dimensioned in such a way that the slider 15 slides downwards without any problems until it reaches the stop 16, thereby reducing the material flow again.

This only temporarily increases the material flow slightly, and a bulk material flow corresponding to the set parameters of the gap height d and the vibration amplitude S is established again.

The gap height d is generally adjusted by a height adjustment device 22, which adjusts the height of the hopper body 14 together with the stop 16 and the slider 15 it holds. This adjustment is generally made before conveying operation and is not changed in the event of material jams.

According to a further embodiment, active adjustment of the slider 15 may also be provided, which is intended to supplement the automatic adjustment in the event of material jam 21. In the embodiment just described, no active adjustment of the slider 15 is therefore provided.

The gap height d, i.e., the distance to the conveying trough 3 set by the slider 15 when it is in contact with the stop 16, can thus be set very low by the height adjustment device 22, e.g., to a minimum gap height of dmin of 1.1 to 2 or 1.4 to 2 of the vertical vibration amplitudes component Sh, i.e. a ratio of V = dmin/Sv in the range from 1.1 to 2 or 1.4 to 2, without jamming, so that very fine dosing of the material throughput MD or a very large range of adjustable material throughput is achieved.

As shown in FIGS. 2A-2C, the geometry of the slider 15 is basically adapted to the geometry of the conveying trough 3, so that a corresponding discharge gap 12 with a defined cross-section or gap cross-section is formed, in particular a discharge gap 12 that extends across the width of the conveying trough; When the conveying trough 3 is configured with a semicircular cross-section 24, the slider 15 preferably also comprises a semicircular shape, so that a uniform, arcuate discharge gap 12 is formed. In the middle embodiment with a rectangular cross-section 24, the slider 15 accordingly comprises a rectangular shape, so that a rectangular discharge gap is formed at the bottom.

As can also be seen from FIGS. 2A-2C, the shape of the slider 15 may deviate slightly from the cross-section of the conveying trough 3. In particular, the slider 15 may have a recess relative to the cross-section of the conveying trough, so that a free channel 23 corresponding to the recess is formed between the slider 15 and the conveying trough 3, in particular at the lower bottom area of the conveying trough 3. Thus, preferably in regular operation, even in the lowest height position of the feed hopper 4, the free channel 23 is formed; according to the present disclosure, it is recognized that this small free channel 23 is not relevant, since no relevant quantities of the bulk material 2 pass through it in the rest state, but the free channel forms a significantly more uniform material flow. With the round cross-section and rectangular cross-section, the free channel 23 can be provided as a central rectangular recess; with the right-hand embodiment with a triangular or V-shaped cross-section 24, the free channel 23 can be formed as a blunt end at the lower end.

Vibratory conveyors are used to convey bulk materials, i.e., free-flowing materials. For this purpose, bulk material is fed into a feed hopper from above and temporarily stored, and then discharged from the feed hopper downwards onto a conveying trough. The conveying trough is periodically driven by a vibration drive, whereby the vibration drive drives the conveying trough in vibrations with a defined vibration frequency and vibration amplitude or throw width, so that the bulk material is conveyed intermittently along the conveying trough in a conveying direction. The feed hopper generally comprises a hopper outlet at its lower end, from which the free-flowing bulk material falls onto the conveying trough and initially remains essentially in the filling area between the hopper outlet and the conveying trough. When the vibration drive is at rest, the free-flowing bulk material generally does not spread to the sides, or only to a limited extent. The vibrations of the vibration drive then throw the bulk material on the conveying trough in the conveying direction, so that the bulk material or stock material taken up in the feed hopper automatically slides down from the hopper outlet onto the conveying trough.

The vibratory conveyor thus provides a defined material throughput, i.e., the amount of material transported per unit of time via the conveying trough, and the bulk material can be transported for subsequent processing, e.g., as feed material to an extruder or a filling station. Various materials can be transported as bulk material, e.g., plastic and rubber, in particular as particles, granules, powder, or flakes, as well as stone, e.g., gravel or sand, and foodstuffs such as flour and grain. Tablets or coated tablets can also be transported.

The material throughput is adjustable on the one hand by the vibration amplitude of the vibration drive and on the other hand by the material cross-section in the conveying trough. The dependence of the material throughput on the vibration amplitude and vibration frequency is generally complex, since leaf springs with a natural frequency are used as vibration drive arms, for example, and the ratio of the excitation frequency specified by the vibration drive to the natural frequency of the oscillating system is relevant, as is the power with which the oscillating system is excited. A change in the vibration amplitude is generally achieved by changing the frequency or excitation frequency and/or the power. However, the vibration amplitude can only be adjusted to a limited extent. For example, at very small vibration amplitudes, the bulk material is generally not set in motion evenly because it does not lift off the conveying trough and thus no throwing conveying is achieved. In this lower range, the material flow tends to be interrupted and there is a non-linear relationship between amplitude and material flow. In a middle range, the desired throwing transport is achieved, in which the material or bulk material detaches from the conveying trough during the course of the vibration and is accelerated by it to a constant speed depending on its deflection. In this middle range, uniform conveying and an almost linear relationship between vibration amplitude and material throughput can thus be achieved. If the vibration amplitude is increased further, an upper range is reached in which the throwing conveying becomes uneven and inefficient, as there is no longer any regular contact between the bulk material and the conveying trough.

Therefore, the middle range of the vibration amplitude is generally targeted and used to adjust the other parameters of the gap height more precisely in order to regulate the material throughput. It should be noted that the adjustable gap height is limited, with the maximum gap height being limited by the height of the trough geometry and the minimum gap height being limited by possible material jams. When material jams, several particles of the bulk material become jammed together in such a way that they block the discharge gap between the feed hopper and the conveying trough. Therefore, the gap height is generally adjusted depending on the grain size of the bulk material. However, even such general estimates are inaccurate, as accumulations of particles with a greater overall height can also form if, for example, particles are unfavourably positioned in relation to each other, and can lead to jamming and thus blocking of the discharge gap, which interrupts the material flow. The oscillating drive and the fill material pressing downwards and in the conveying direction thus form such material jams, which generally cannot be resolved; instead, the vibration drive presses the material against the hopper outlet and jams it further.

The discharge gap and thus the gap height are adjusted by means of a height adjustment mechanism, which adjusts the entire feed hopper relative to the conveying trough. If a material jam occurs, the height adjustment can be activated or the material jam can be released by a user using an additional tool; however, this needs monitoring and active modification, and delays and major fluctuations in material throughput occur.

Therefore, vibratory conveyors may be provided for different types of material in order to achieve suitable adjustment ranges for height adjustment and discharge gap adjustment depending on the type of material or grain size.

One comparative device has a conveyor pipe or conveyor trough with a vibrating drive and a scraper limiting the inflow cross-section for the conveyed material, whereby the conveyor cross-section is reduced to a certain conveyor length behind the scraper in order to stabilise the conveyor flow.

Another comparative device for feeding material onto a conveyor belt, in which a bulk material hopper feeds the material into a vibrating chute with an adjustable inclination, in the upper part of which a series of swivelling flaps are suspended, which are pushed open by larger lumps of bulk material.

Another comparative dosing device with at least one dosing container, which is provided with at least one outlet opening that can be closed by a slide valve connected to a slide valve drive.

The present disclosure is therefore based on the object to provide a vibratory conveyor and a method for vibratory conveying bulk material, which enable safe vibratory conveying and good adjustability of the material throughput with little effort.

This task is solved by a vibratory conveyor and a method according to the independent claims. The dependent claims describe preferred further developments.

Thus, the feed hopper comprises a hopper body and a slider that is adjustable vertically on the hopper body, whereby the hopper outlet, from which the filling material is discharged onto the conveying trough via a discharge gap, is formed on the slider.

In particular, the slider is not actively adjusted upwards, but is pressed downwards against a stop, in particular a stop on the hopper body, by a total force. The total force includes the gravitational force of the slider; it can be formed in particular by the gravitational force itself, so that the slider is pressed down against the stop by its own gravitational force, or also by the gravitational force and an additional downward spring force.

The adjustability of the slider thus differs from the height adjustment of the entire feed hopper relative to the conveying trough for adjusting the discharge gap; In the comparative height adjustment of the entire feed hopper relative to the conveying trough, the hopper body and the slider are adjusted together to set the gap height for the proper material throughput;

In contrast, the vertical adjustment of the slider on the hopper body according to the present disclosure is advantageously performed passively by the action of an upward force of the filling material on the lower edge of the slider, i.e., the hopper outlet. This upward force is caused by material jam in the discharge gap.

This relatively simple measure can surprisingly achieve a significant improvement in conveying operation and, in particular, prevent material jam even at low gap heights:

According to the present disclosure, it is recognized that when material jams, a solid accumulation of material is formed between the conveying trough and the hopper outlet, which during operation, i.e., vibration of the conveying trough, presses against the outlet opening and thus the hopper from below. By attaching the hopper outlet to a vertically adjustable slider, the slider is moved directly vertically upwards, i.e., against its gravitational force, when such a material jam occurs, so that the slider opens automatically upwards when a material jam occurs, thereby increasing the discharge gap and the gap height.

According to the present disclosure, the problem of material jam may arise when the accumulation of particles of the filling material exerts a force on the hopper outlet from below due to the oscillating drive, and the hopper outlet exerts a counterforce downward in response to this. This counterforce enables the force connection from the hopper outlet to the conveying trough via the particles, in order to reduce this influence, the present disclosure reduces the counterforce that the slider can exert. To this end, the comparative fixed positioning of the lower hopper outlet is eliminated and the slider is given the opportunity to yield against the upward force. Thus, in particular, the maximum counterforce that it can exert is limited to a total force acting downward.

It can be seen that the total downward force acting on the slide valve is basically sufficient to counteract its own vertical gravitational force; in addition, a downward spring force, in particular a travel-dependent spring force, can be used.

In this case, the total force exerted downward by the slider is sufficient to prevent it from being displaced upward by the conveyed bulk material during regular operation and material transport, or at least to prevent any significant displacement. If the bulk material in the conveying trough is a fully fluidized material, the bulk material exerts a static buoyancy force on the slider, which is generally low, however. According to the present disclosure, it has been shown that the transported fluidized bulk material does not exert any relevant buoyancy and that the total force acting on the slider, i.e., in particular its gravitational force, is sufficient to provide that it can be safely moved back to the lower position.

The total force thus also provides that the slider is reset after a material jam; the material jam pushes the slider upward until the force connection is released and the material jam is cleared, allowing the slider to fall back down against its stop due to the total force. This also prevents the gap from being pushed open further and further by subsequent material flow or from remaining open.

This means that the fundamentally disadvantageous friction that occurs when material jams between the conveying trough and the lower hopper outlet now formed on the slider can be exploited in accordance with the present disclosure to briefly open the gap height by adjusting the slider, whereupon, with normal material flow, there is no longer sufficient vertical upward force and the slider can thus fall downwards into its basic position.

The lower position or basic position is determined by a stop, which is preferably provided on the hopper body or relative to the hopper body.

The conveying trough is not limited to a rectangular chute geometry; other chute geometries, such as a V-shape or round cross-section, may also be provided. Furthermore, the slider is not limited to the exact cross-section of the conveying trough, but may also deviate from it to some extent and thus feed material into parts of the chute even when the minimum discharge gap is set. This means that channels can be provided in which material is transported at the minimum gap setting, resulting in more uniform conveying behavior.

According to the present disclosure, the adjustable slider differs in particular from, for example, merely flexible designs such as a rubber flap or other flexible lower ends. Such a flexible lower end as a rubber flap cannot define an exact gap height, as it yields under the pressure of the bulk material in the conveying direction, i.e., even without material jam, which prevents the material throughput from being set precisely.

According to the present disclosure, in particular, no adjustment is exerted by pressure from the material acting in the conveying direction, i.e. – different to rubber flaps and other flexible boundaries – no adjustment is caused by the material flow, and only the force connection between the conveying trough and the hopper outlet provided on the slider leads to the vertical force that adjusts the slider upwards via the oscillating drive.

Since the shape of the slider, which also forms the lower hopper outlet, basically corresponds to the cross-section of the conveying trough, a uniform discharge gap is formed across the width. Preferably, the shape of the slider may deviate slightly from the cross-section of the conveying trough; in particular, the slider may have a recess relative to the cross-section of the conveying trough, so that a free channel corresponding to the recess is formed between the slider and the conveying trough, in particular at the lower bottom area of the conveying trough. Thus, even in the lowest position of the slider, the free channel is preferably formed; according to the present disclosure, it is recognized that this small free channel is not relevant, since no relevant quantities of bulk material pass through it in the rest state, but the free channel forms a significantly more uniform material flow.

### LIST OF REFERENCE NUMERALS

1 vibratory conveyor

2 bulk material

3 conveying trough

4 feed hopper

5 material supply

6 vibration drive

7 vibration driver arms, leaf springs

8 vibration driver base

10 hopper outlet, lower hopper outlet

12 Discharge gap between the hopper outlet 10 and the conveying trough 3

14 Hopper body of the feed hopper 4

15 slider

16 stop for fixing the discharge gap 12

18 spring

20 particle

21 material jam

22 height adjustment device

23 free channel

24 cross-section of the conveying trough 3

d gap height

F conveying direction

S vibration amplitude

Sh vertical component of the vibration amplitude

MD material throughput

1. A vibratory conveyor for transporting bulk material, the vibratory conveyor comprising:
a feed hopper with a hopper outlet formed at the lower end of the feed hopper,
a conveying trough, and
a vibration drive for driving the conveying trough with a vibration amplitude and a vibration frequency,
wherein a discharge gap with a gap height is formed between the hopper outlet and the conveying trough,
wherein the hopper comprises a hopper body and a slider that is vertically adjustable on the hopper body,
wherein the hopper outlet is formed on the slider, wherein the slider is vertically adjustable upwards relative to the hopper body from a lower stop, thereby enlarging the discharge gap.

2. The vibratory conveyor of claim 1, wherein it comprises a height adjustment device for adjusting the height of the feed hopper relative to the conveying trough, wherein the discharge gap and the gap height are adjustable by the height adjustment device.

3. The vibratory conveyor of claim 1, wherein, during operation of the vibration drive, the slider is vertically adjustable upwards by the bulk material in the event of a material jam of the bulk material.

4. The vibratory conveyor of claim 1, wherein a total force acts downwards on the slider, which is formed by: the gravitational force of the slider, or
the sum of the gravitational force of the slider and a spring force.

5. The vibratory conveyor of claim 4, wherein the spring force is a spring force of a spring provided between the hopper body and the slider.

6. The vibratory conveyor of claim 1, wherein a material supply is provided above the feed hopper for feeding the bulk material into the feed hopper.

7. The vibratory conveyor of claim 1, wherein the slider is mounted on the outside of the hopper body in an adjustable manner.

8. The vibratory conveyor of claim 1, wherein the height adjustment device allows a gap height to be set to a minimum value of a minimum gap height,
wherein the minimum gap height is in a ratio V to a vertical component of the vibration amplitude of V = dmin/Sv > 1.

9. The vibratory conveyor of claim 8, wherein the ratio V is characterized by one of V >= 1.1, V >= 1.4, and V >= 2.

10. The vibratory conveyor of claim 1, wherein the slider comprises a different cross-section than the conveying trough.

11. The vibratory conveyor of claim 10, wherein the cross-section of the slider differs from the cross-section of the conveying trough by means of a free channel in the conveying trough, wherein the free channel is also exposed at a minimum gap height set by the height adjustment device.

12. The vibratory conveyor of claim 11, wherein the cross-section of the slider differs from the cross-section of the conveying trough at a lower point of the conveying trough.

13. A method for vibratory conveying of bulk material with the vibratory conveyor according to claim 1, wherein the bulk material is fed into the feed hopper from above, reaches the conveying trough downwards at the hopper outlet, and is transported on the conveying trough in a conveying direction with a material throughput.

14. The method of claim 13, wherein, during operation of the vibration drive in the event of a material jam of the bulk material, the slider is moved vertically upwards by the bulk material, thereby enlarging the discharge gap.

15. The method of claim 13, wherein, during uncongested transport of the bulk material on the conveying trough, the slider is not displaced by the vibration drive and the bulk material and remains on the stop.

16. The method of claim 13, wherein, when the bulk material is transported without congestion on the conveying trough, the buoyancy of the fluidized bulk material acting on the slider is less than the total force acting downwards on the slider.

17. The method of claim 13, wherein the material throughput of the bulk material through the conveying trough depends on the vibration frequency, the vibration amplitude, and a gap height.

18. The method of claim 13, wherein one or more of the following materials are transported as bulk material: plastic, rubber, gravel, stone, sand, foodstuff, coated pellets, and/or powder.

19. The method of claim 13, wherein the height adjustment device allows a gap height to be set to a minimum value of a minimum gap height, which is in a ratio to a vertical component of the vibration amplitude of V = dmin/Sv > 1.

20. The method of claim 19, wherein the ratio is characterized by one of V >= 1.1, V >= 1.4, and V >= 2.
